(19) United States
(12) Patent Application Publication
(10) Pub. No.: US 2010/0238250 A1
(43) Pub. Date: Sep. 23, 2010

(54) Image forming device

(75) Inventor: Yasuhiko Kachi, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/659,100

(22) Filed: Feb. 25, 2010

(30) Foreign Application Priority Data
Mar. 23, 2009 (JP) 2009-069986

(51) Int. Cl. B41J 2/01

(52) U.S. Cl. 347/104

(57) ABSTRACT

An image forming device provided with: a recording head that renders an image by ejecting liquid droplets onto a recording medium; an attraction image rendering section having a liquid droplet reception flat portion disposed facing the recording head, the attraction image rendering section attracting the recording medium onto the flat portion and maintaining the flatness of the recording medium; an upstream side conveying section that feeds the recording medium out toward the attraction image rendering section; and a reverse-feed-prevented conveying roller disposed at the downstream side of the attraction image rendering section, the reverse-feed-prevented conveying roller being capable of friction-pushed rotation toward the conveying direction downstream side, nipping the recording medium and feeding the recording medium toward the conveying direction downstream side, and prevented from rotation toward the conveying direction upstream side.

### CROSS-REFERENCE TO RELATED APPLICATIONS

This application claims priority under 35 USC 119 from Japanese Patent Application No. 2009-069986 filed on Mar. 23, 2009, the disclosure of which is incorporated by reference herein.

### BACKGROUND OF THE INVENTION

1. Technical Field

The present invention relates to an image forming device, and in particular to an image forming device that forms an image on a recording medium by ejecting a liquid onto the recording medium.

2. Related Art

Image forming devices that form images on recording media by ejection of a liquid, such as ink, are widely known. In such image forming devices, the recording medium is conveyed to directly below a recording head, and an image is rendered.

In such image forming devices, since any non-uniformity in the separation distance between the recording head and the recording medium has an effect on image rendering, correction to maintain the recording medium in a flat shape is already sometimes performed.

For example, in Japanese Utility Model Application Laid-Open No. 01-44149, the feeding speed of recording medium further to the downstream side of a recording section is made faster than to the upstream side thereof, and by slippage of the drive shaft at the downstream side using a torque limiter, a back tension is applied to the recording medium in the recording section, ensuring the flatness of the recording medium. However, there are problems with such a method in that generation of longitudinal creases sometimes occurs due to tensioning the recording medium, and slippage of the drive shaft sometimes occurs due to influence from the conveying direction downstream side.

Also, in Japanese Patent Application Laid-Open (JP-A) No. 2006-56655, flatness in a recording section is ensured by employing suction generation means, and by provision of a loop shaped section between the recording section and a cutter section, influence from the loop shaped section is suppressed, thereby suppressing flapping of the recording medium at the upstream side of the plural roller loop shaped section. However, in the technology of Japanese Patent Application Laid-Open (JP-A) No. 2006-56655, since there is a strong gripping force employed at the downstream side of the recording section, slackness of the recording medium in the recording section readily develops when the feed speed at the upstream side is fast. In addition, when the speed at the downstream side is fast, slippage is sometimes generated relative to the image face of the recording medium, this being a cause of image quality deterioration. Also, since plural rollers are also required, this increases the number of components.

### SUMMARY OF THE INVENTION

The present invention is made in consideration of the above circumstances, and addresses the issue of provision of an image forming device capable of ensuring a high precision of flatness of a recording medium in a recording section.

An image forming device of a first aspect includes: a recording head that renders an image by ejecting liquid droplets onto a recording medium; an attraction image rendering section having a liquid droplet reception flat portion disposed facing the recording head, the attraction image rendering section attracting the recording medium onto the flat portion and maintaining the flatness of the recording medium; an upstream side conveying section that feeds the recording medium out toward the attraction image rendering section; and a reverse-feed-prevented conveying roller disposed at the downstream side of the attraction image rendering section, the reverse-feed-prevented conveying roller being capable of friction-pushed rotation toward the conveying direction downstream side, nipping the recording medium and feeding the recording medium toward the conveying direction downstream side, and prevented from rotation toward the conveying direction upstream side.

In the image forming device configured as described above, image rendering (recording) is performed to the recording medium on the flat portion of the attraction image rendering section. The flatness of the recording medium on the flat portion is maintained by attracting the recording medium onto the flat portion. The reverse-feed-prevented conveying roller that is disposed at the downstream side of the attraction image rendering section, nips the recording medium and is capable of pushed rotation toward the conveying direction downstream side due to friction against the recording medium (friction-pushed rotation). Consequently, the recording medium can be conveyed between the upstream side conveying section and the reverse-feed-prevented conveying roller at the feed speed of the upstream side conveying section. In addition, the reverse-feed-prevented conveying roller is prevented from rotation toward the conveying direction upstream side, therefore influence to the upstream side, due to slackness in the recording medium at the downstream side of the reverse-feed-prevented conveying roller or the like, can be suppressed.

In an image forming device of a second aspect, the reverse-feed-prevented conveying roller is capable of being rotationally driven toward the conveying direction downstream side at a conveyance speed that is the same as, or less than, a conveyance speed of the upstream side conveying section.

The reverse-feed-prevented conveying roller conveys the recording medium by friction-pushed rotation with the feed speed of the upstream side conveying section, however on occasions such as when the downstream side edge of the recording medium has passed through the upstream side conveying section or the like, driving force for conveying the recording medium is required. In order to address this, by the reverse-feed-prevented conveying roller being capable of being rotationally driven in this manner toward the conveying direction downstream side at a conveyance speed that is the same as, or less than, a conveyance speed of the upstream side conveying section, the recording medium can be conveyed while ensuring the flatness thereof.

In an image forming device of a third aspect, the reverse-feed-prevented conveying roller nips the recording medium against the top face of the flat portion.

According to the above configuration, buckling of the recording medium can be suppressed, since there is no separation between the flat portion and the reverse-feed-prevented conveying roller.

In an image forming device of a fourth aspect, the relationship S<2π(E×I/F)^{1/2} is satisfied, wherein: S is a separation distance between the downstream end of the flat portion and a nip portion of the recording medium at the reverse-feed-prevented conveying roller; F is the friction-pushed load on the reverse-feed-prevented conveying roller; E is the Young's modulus of the recording medium; and I is the area moment of inertia of the recording medium.

By setting in this manner, buckling of the recording medium between the flat portion and the reverse-feed-prevented conveying roller can be suppressed.

In an image forming device of a fifth aspect, the recording medium is fed out from a wound state of a roll shape toward the flat portion with an unwind direction having the convex face of the recording medium facing toward the recording head in the attraction image rendering section.

By setting any curl due to winding in the recording medium in the direction described above, the flatness can be more effectively ensured by attraction toward the flat portion in the attraction image rendering section, in comparison to cases disposed in the opposite direction.

An image forming device of a sixth aspect, further includes: second conveying rollers that are provided at the conveying direction downstream side of the reverse-feed-prevented conveying roller, and that nip the recording medium and convey the recording medium toward the downstream side; a cutter section that cuts the recording medium to a specific size; and a curved conveying section that is provided between the reverse-feed-prevented conveying roller and the second conveying rollers and that bends the recording medium and accommodates any difference in conveying amounts between the reverse-feed-prevented conveying roller and the second conveying rollers due to conveyance being stopped in the cutter section when the recording medium is being cut.

When a curved conveying section is provided in this manner so as to accommodate any difference in conveying amount of the recording medium when conveying is stopped during cutting by a cutter section disposed at the downstream side of the attraction image rendering section, the reverse-feed-prevented conveying roller is preferably employed since external force readily acts on the recording medium on the attraction image rendering section due to influence from the curved conveying section.

In an image forming device of a seventh aspect, the direction of curvature of the recording medium in the curved conveying section is the same direction as the winding direction of the recording medium.

By setting the direction of curvature of the recording medium in this manner, the reaction force of the recording medium in the curved conveying section is smaller than would be the case were the opposite direction to be adopted, and influence on the reverse-feed-prevented conveying roller can be decreased.

In an image forming device of an eighth aspect the direction of curvature of the recording medium in the entire region between the reverse-feed-prevented conveying roller and the second conveying rollers is the same as the winding direction of the recording medium.

By setting the direction of curvature of the recording medium as above, the reaction force of the recording medium between the reverse-feed-prevented conveying roller and the second conveying rollers can be made even smaller, and influence on the reverse-feed-prevented conveying roller can be decreased.

According to the present invention a high precision of flatness of a recording medium in a recording section can be ensured.

### BRIEF DESCRIPTION OF THE DRAWINGS

Exemplary embodiments of the present invention will be described in detail based on the following figures, wherein:

FIG. 1 is a schematic configuration diagram showing an image forming device according to a first exemplary embodiment;

FIG. 2 is a perspective view showing a configuration of an image forming device according to the first exemplary embodiment in the vicinity of an attraction image rendering section;

FIG. 3 is a schematic configuration diagram of an image forming device according to an exemplary modification of the first exemplary embodiment;

FIG. 4 is a schematic configuration diagram of an image forming device according to another exemplary modification of the first exemplary embodiment;

FIG. 5 is a schematic configuration diagram of an image forming device according to another exemplary modification of the first exemplary embodiment;

FIG. 6 is a schematic configuration diagram of an image forming device according to another exemplary modification of the first exemplary embodiment;

FIG. 7 is a side view of a schematic configuration diagram of an image forming device according to a second exemplary embodiment;

FIG. 8 is a perspective view showing a conveyor belt of an image forming device according to the second exemplary embodiment; and

FIG. 9 is a side view of a schematic configuration diagram of an image forming device according to an exemplary modification of the second exemplary embodiment.

### DETAILED DESCRIPTION OF THE INVENTION

### First Exemplary Embodiment

Explanation will now be given of an exemplary embodiment of the present invention, with reference to the drawings.

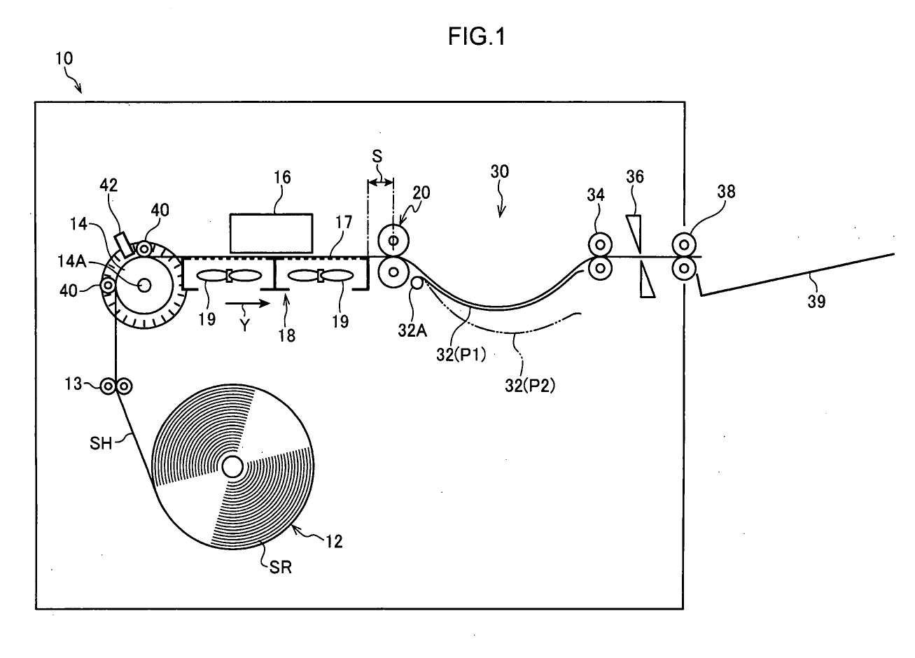

As shown in FIG. 1, an image forming device 10 according to the present exemplary embodiment is equipped with: a roll-paper feed section 12; a slow-scan roller 14; a recording head 16; an attraction image rendering section 18; first conveying rollers 20; second conveying roller 34; a cutter 36; a curved conveying section 30; discharge rollers 38; and a paper discharge tray 39.

The roll-paper feed section 12 is stocked, as a recording medium, with elongated recording paper SH wound into a roll shape to form a roll recording paper (continuous paper) SR. Examples of the recording paper SH include ordinary paper, inkjet recording paper that has an ink absorbing layer on both faces thereof, and the like. The roll recording paper SR is unwound toward the conveying direction downstream side, by a conveying roller 13 or the like, and is conveyed out as a web (in an uncut elongated shape). It should be noted that while in the present exemplary embodiment explanation is given of image rendering on roll recording paper, an image forming device additionally provided with a cassette stacked with cut sheets of paper and capable of also rendering images on cut sheets may also be used.

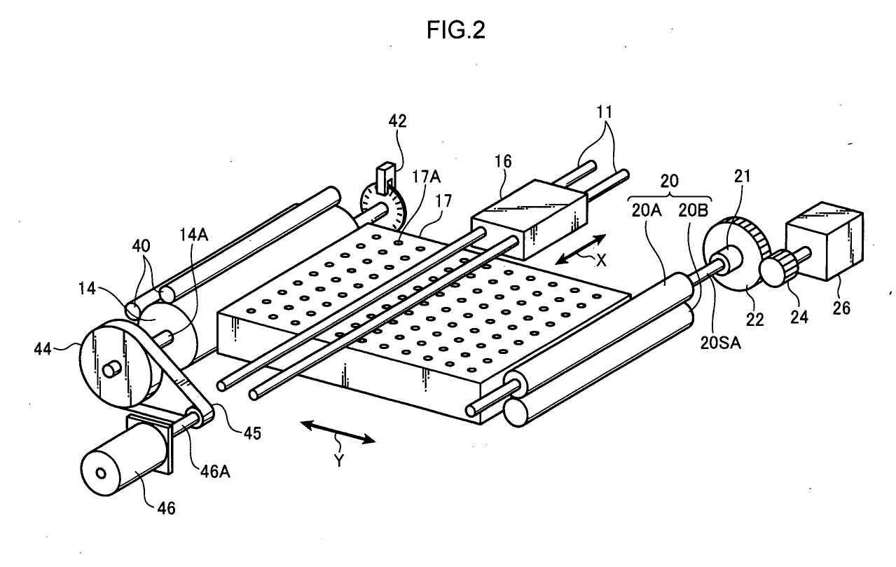

The recording head 16, as shown in FIG. 2, is mounted to guide shafts 11, and is capable of moving along the guide shafts 11 in the width direction of the recording paper SH (this direction is referred to below as “fast-scanning direction X”). Nozzles (not shown in the figures) that eject ink are configured on the bottom face of the recording head 16, and an image is formed on the recording paper SH by ink being ejected from the nozzles in accordance with image data.

As shown in FIG. 1, the attraction image rendering section 18 is disposed below the bottom face of the recording head 16 and facing the recording head 16. The attraction image rendering section 18 includes a flat portion 17 formed at the top face thereof, and suction fans 19 housed therein.

The top face of the flat portion 17 is formed in a flat shape that is disposed so as to face the recording head 16 and be parallel thereto. The flat portion 17 is configured with plural small holes 17A passing through to the inside of the attraction image rendering section 18. The suction fans 19 draw in air so as to form a negative pressure within the attraction image rendering section 18. The recording paper SH on the attraction image rendering section 18 is thereby attracted onto the flat portion 17 by air being drawn in through the small holes 17A, and flatness is maintained. Ink is ejected toward the recording paper SH on the flat portion 17 and an image is formed.

The slow-scan roller 14 is disposed at the conveying direction upstream side of the attraction image rendering section 18. A pulley 44 is attached at one end of a rotation shaft 14A of the slow-scan roller 14. The pulley 44 is connected to a motor shaft 46A of a motor 46 via a belt 45, transmitting driving force of the motor 46 to the slow-scan roller 14.

Presser rollers 40 are disposed at the outer peripheral face of the slow-scan roller 14. The recording paper SH is nipped by the slow-scan roller 14 against the presser rollers 40 and fed toward the attraction image rendering section 18. The recording paper SH is fed out to the conveying direction downstream side such that the outside face of the recording paper SH, when wound in a roll shape, faces toward the recording head 16. The feeding out direction will be referred to below as “slow-scan direction Y”. Rendering of images onto the recording paper SH is performed, based on image data, by scanning the recording head 16 in the fast-scanning direction X, and by repeatedly feeding out the recording paper SH in the slow-scan direction Y. The conveyance speed of the recording paper SH at the slow-scan roller 14 is referred to as V0.

An encoder 42 is attached to the other end of the rotation shaft 14A of the slow-scan roller 14. The encoder 42 feeds back to the motor 46 the amount by which the recording paper SH has been fed by the slow-scan roller 14. Driving of the motor 46 is controlled based on the feed amount data from the encoder 42, and the recording paper SH is intermittently fed in the slow-scan direction Y.

Note that, as a method for raising the precision of feeding the recording paper SH, a high resolution encoder may be employed as the encoder, and, by identifying outer diameters and deflection data for the slow-scan roller 14 in advance, the feed amount due to the rotation angle of the slow-scan roller 14 may be corrected.

The first conveying rollers 20 are disposed at the downstream side of the attraction image rendering section 18. The first conveying rollers 20 are configured from a pair of first rollers 20A, 20B. A gear 22 is attached to one end of a rotation shaft 20S of the first roller 20A, and driving force of a motor 26 is transmitted to the first roller 20A through gears 22, 24. The gear 22 is attached to the rotation shaft 20S through a one-way clutch 21. Due to the one-way clutch 21, the rotation shaft 20S performs slipping rotation with respect to the gear 22 when a specific rotation load toward the conveying direction downstream side is applied. Consequently, the first conveying rollers 20 are capable of friction-pushed rotation in the conveying direction downstream side when a specific friction-pushed load is applied. Rotation of the rotation shaft 20S toward the conveying direction upstream side is prevented by the one-way clutch 21.

The relationship of Equation 1 below is satisfied, wherein: S is the separation distance between the downstream end of the flat portion 17 of the attraction image rendering section 18 and the nip portion of the recording paper SH in the first conveying rollers 20; E is the Young's modulus of the recording paper SH; I is the area moment of inertia of the recording paper SH; and F is the friction-pushed rotational load on the first conveying rollers 20 toward the conveying direction downstream side.

S<2π(E×I/F)^{1/2} (Equation 1)

By satisfying Equation 1 above, bucking of the recording paper SH between the downstream end of the flat portion 17 of the attraction image rendering section 18 and the first conveying rollers 20 can be prevented.

The recording paper SH is nipped between the first roller 20A and the first roller 20B and fed toward the conveying direction downstream side. The conveyance speed due to driving the first conveying rollers 20 by the motor 26 is designated V1. Conveyance speed V1 is the same as, or less than, the conveyance speed V0 at the slow-scan roller 14 (V1≦V0).

The curved conveying section 30 is provided at the downstream side of the first conveying rollers 20. A moveable guide 32 is provided in the curved conveying section 30. The moveable guide 32 is curved in a U-shape from the first conveying rollers 20 to second conveying rollers 34, described below. The moveable guide 32 is capable of swinging, about an end shaft 32A on the first conveying rollers 20 side of the moveable guide 32, between a guide position P1 and an open position P2. In the curved conveying section 30, the recording paper SH is conveyed in a U-shape in order to absorb any difference in conveying amount at the first conveying rollers 20 and the conveying amount at the second conveying rollers 34. The direction of curve of the bottom of the U-shape is the opposite direction to the wind direction of the roll recording paper SR (the opposite direction to any curl that has been formed in the recording paper SH).

The second conveying rollers 34 are disposed at the downstream side end of the curved conveying section 30, nipping the recording paper SH between a pair of second rollers 34A, 34B. The second conveying rollers 34 are connected to a non-illustrated motor and the recording paper SH is conveyed by rotation toward the downstream side.

The cutter 36 is provided at the downstream side of the second conveying rollers 34. The recording paper SH is cut into a specific size by the cutter 36.

The discharge rollers 38 are disposed at the downstream side of the cutter 36, and the paper discharge tray 39 is disposed at the downstream side of the discharge rollers 38. The recording paper SH is discharged into the paper discharge tray 39 by the discharge rollers 38.

In the image forming device 10 configured as above, conveying of the recording paper SH and image rendering on the recording paper SH are performed as described below.

The recording paper SH is unwound and fed from the roll-paper feed section 12 toward the conveying direction downstream side by the conveying roller 13 or the like, and fed toward the slow-scan roller 14. The recording paper SH is fed out toward the attraction image rendering section 18, while being pressed to the outer periphery of the slow-scan roller 14 by the presser rollers 40. In the attraction image rendering section 18 the recording paper SH is conveyed out in the slow-scan direction Y, while the recording paper SH is attracted onto the top face of the flat portion 17 by the negative pressure due to the suction fans 19.

In the attraction image rendering section 18, image rendering on the recording paper SH is performed, based on image data, by repeatedly scanning the recording head 16 in the fast-scanning direction X and feeding the recording paper SH out in the slow-scan direction Y, using the slow-scan roller 14.

The recording paper SH is nipped in the first conveying rollers 20 at the downstream side of the attraction image rendering section 18. When this occurs, since the conveyance speed V1 of the first conveying rollers 20 is the same as, or less than, the conveyance speed V0 of the slow-scan roller 14, the first conveying rollers 20 are usually friction-pushed rotated toward the conveying direction downstream side, rotated friction-pushed load from the recording paper SH toward the downstream side, and the recording paper SH is fed out at a conveyance speed V0. Due to the recording paper SH being conveyed in this manner by the friction-pushed rotation of the first conveying rollers 20, generation of longitudinal creases, due to pulling recording paper toward the conveying direction downstream side, can be suppressed. Note that after the trailing edge of the recording paper SH has passed the slow-scan roller 14 the recording paper SH is conveyed by driving the first conveying rollers 20.

After passing the first conveying rollers 20, the recording paper SH is conveyed along a U-shaped conveying path and nipped in the second conveying rollers 34. Up until the leading edge of the recording paper SH is nipped by the second conveying rollers 34, the moveable guide 32 is positioned in the guide position P1, guiding the leading edge of the recording paper SH into the second conveying rollers 34. After the leading edge of the recording paper SH has been nipped by the second conveying rollers 34, the moveable guide 32 is moved to the open position P2, and a degree of freedom is added to the conveying amount of the recording paper SH.

The recording paper SH is fed out toward the cutter 36 by the second conveying rollers 34. The second conveying rollers 34 stop conveying the recording paper SH when the recording paper SH is being cut in the cutter 36, and the second conveying rollers 34 convey the recording paper SH when not cutting. When the second conveying rollers 34 are stopped, the length of the recording paper SH in the curved conveying section 30 gets longer, since the conveying amount at the first conveying rollers 20 is greater than the conveying amount at the second conveying rollers 34. This extra length of the recording paper SH is accommodated in the curved conveying section 30.

When this occurs, the recording paper SH curved in the curved conveying section 30 acts to apply external force to the first conveying rollers 20 in the opposite direction to the conveying direction, however the first conveying rollers 20 are prevented from rotating in the opposite direction to the conveying direction by the one-way clutch 21. Consequently, the recording paper SH is not reverse-conveyed toward the attraction image rendering section 18 side, external force from the curved conveying section 30 is blocked, and good image rendering can be performed in the attraction image rendering section 18.

The recording paper SH that has been cut in the cutter 36 is discharged into the paper discharge tray 39 by the discharge rollers 38.

As explained above, according to the present exemplary embodiment, since the first conveying rollers 20 feed out the recording paper SH by friction-pushed rotation due to load from the recording paper SH fed out from the slow-scan roller 14, generation of longitudinal creases, due to action of tension on the recording paper SH toward the conveying direction downstream side, can be suppressed. Since the first conveying rollers 20 are prevented from rotating in the opposite direction to the conveying direction, there is no influence of external force from the curved conveying section 30 to the attraction image rendering section 18, and good image rendering can be performed on the recording paper SH.

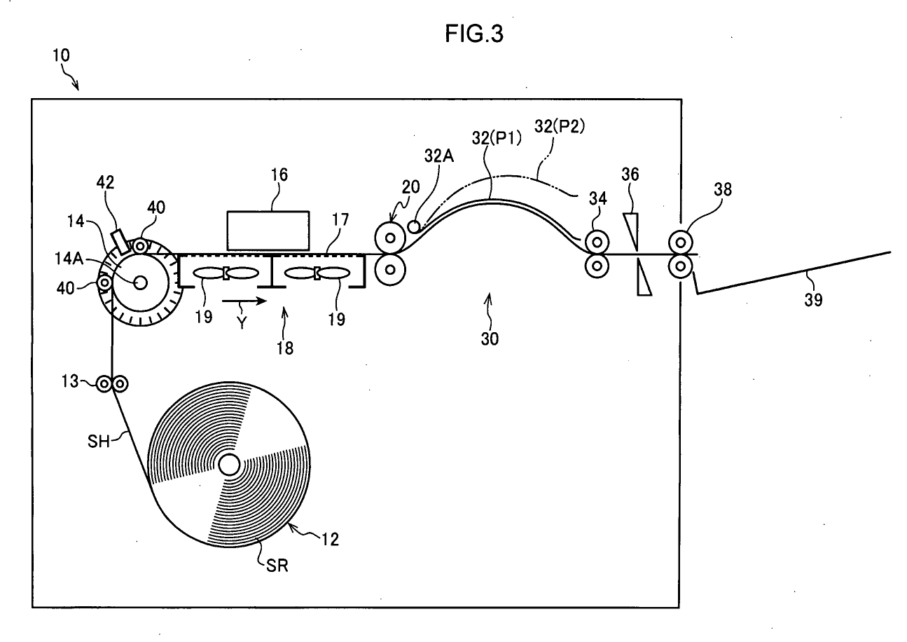

It should be noted that while in the present exemplary embodiment the direction of curvature of the recording paper SH in the U-shaped bottom portion of the curved conveying section 30 is the opposite direction to the winding direction of the roll recording paper SR, the direction of curvature may be the same direction as the winding direction of the roll recording paper SR, as shown in FIG. 3. By making the direction of curvature the same as the winding direction of the roll recording paper SR in this manner, external force on the first conveying rollers 20 due to curvature can be suppressed.

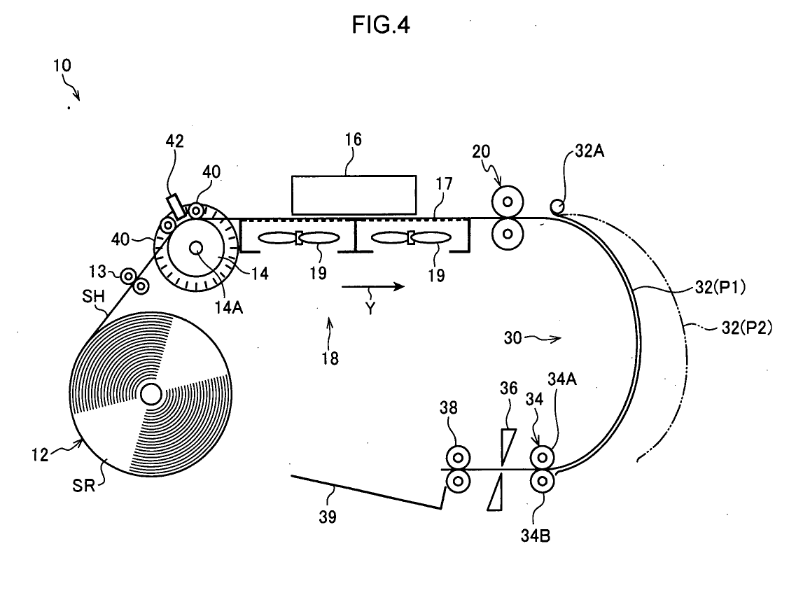

In addition, as shown in FIG. 4, the conveying path may be configured such that the direction of curvature of the recording paper SH is the same direction to the winding direction of the roll recording paper SR for the whole region, namely the whole of the conveying path in the section from the nip portion of the recording paper SH in the first conveying rollers 20 to the nip portion of the recording paper SH in the second conveying rollers 34, not just the direction of curvature of the U-shaped bottom portion of the recording paper SH. In this manner, due to there being no portions in which the direction of curvature of the recording paper SH is the opposite direction to the winding direction of the roll recording paper SR, the application of external force to the first conveying rollers 20 due to winding curl can be effectively suppressed.

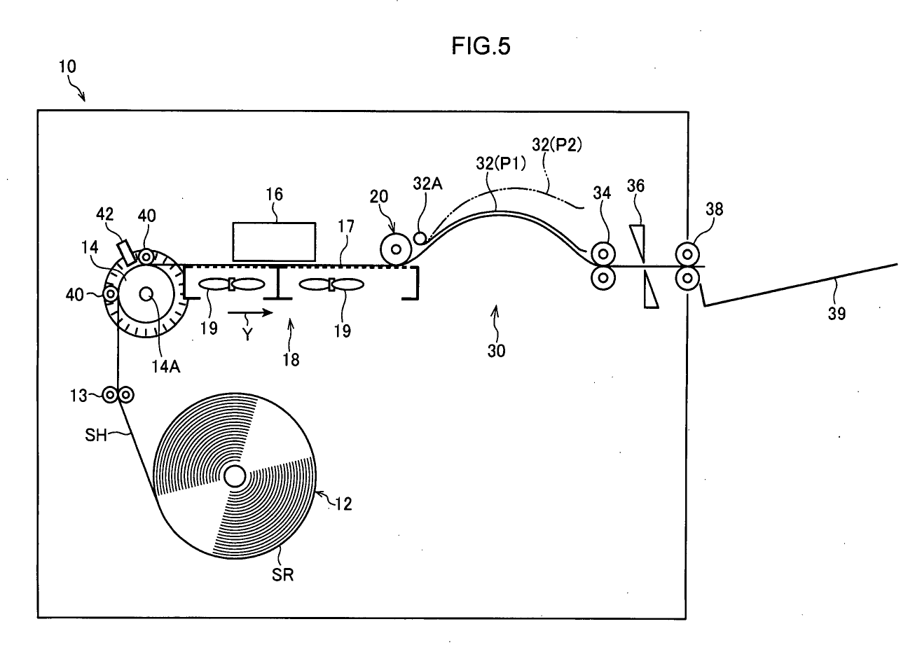

Also, while in the present exemplary embodiment the first conveying rollers 20 are disposed further to the downstream side than the attraction image rendering section 18, the first roller 20A alone may be disposed above the flat portion 17 at the attraction image rendering section 18 side, as shown in FIG. 5. In such cases, the recording paper SH is nipped between the first roller 20A and the flat portion 17.

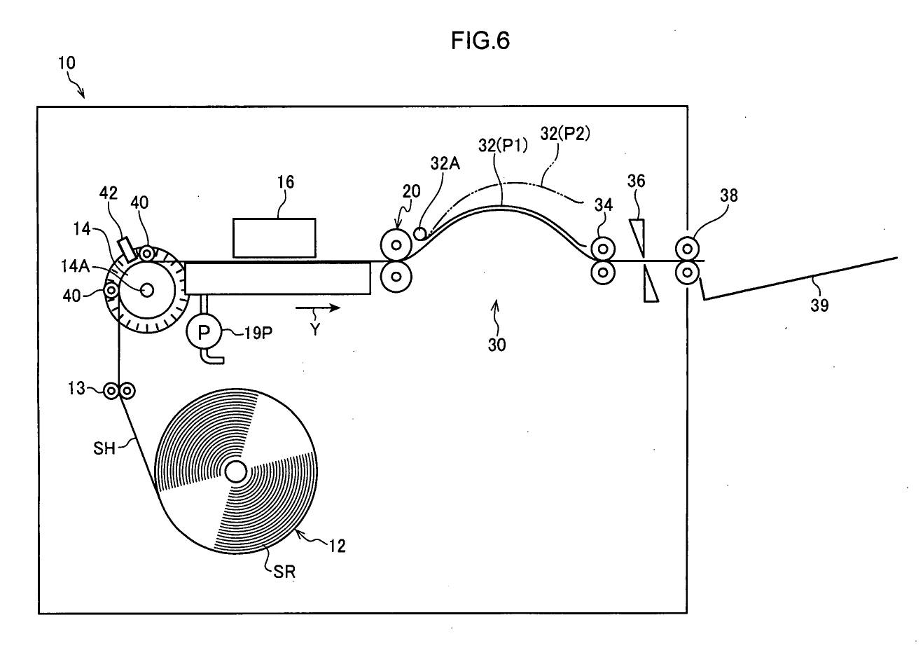

Furthermore, while explanation has been given in the present exemplary embodiment of an example where suctioning in the attraction image rendering section 18 is performed by suction fans 19, a suction pump 19P may be employed for suctioning, as shown in FIG. 6. In such cases, the suction pump 19P is connected to the attraction image rendering section 18, and the recording paper SH is attracted onto the flat portion 17 by negative pressure within the attraction image rendering section 18 due to the suction pump 19P, and the flatness of the recording paper SH in the attraction image rendering section 18 can be secured.

### Second Exemplary Embodiment

Explanation will now be given of a second exemplary embodiment of the present invention. The present exemplary embodiment is provided with an attraction image rendering section 50 in place of the attraction image rendering section 18 of the first exemplary embodiment. Since other parts of the configuration are similar to that of the first exemplary embodiment, the same reference numerals will be allocated thereto, and detailed explanation thereof omitted.

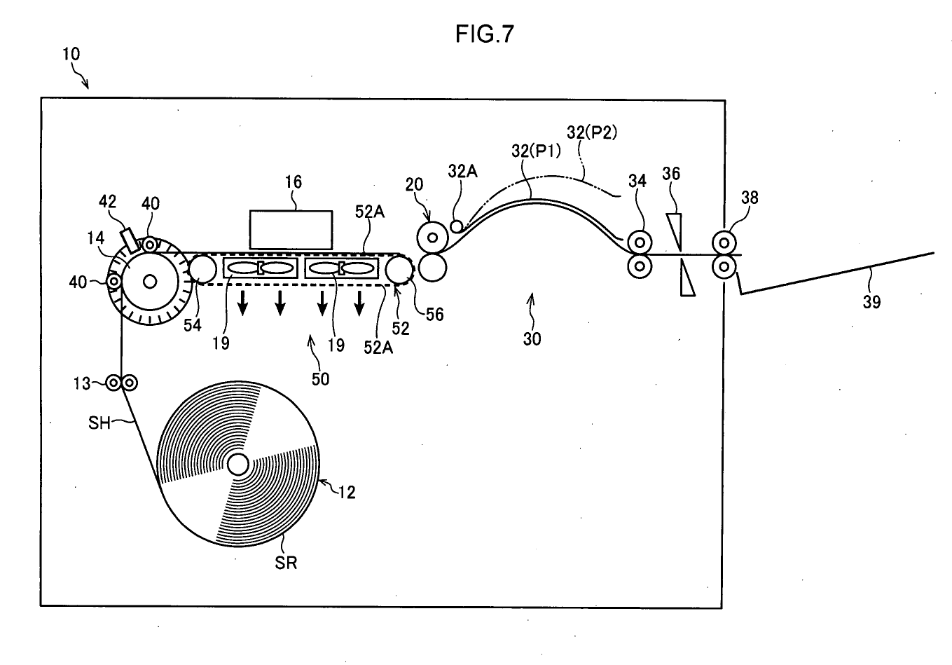

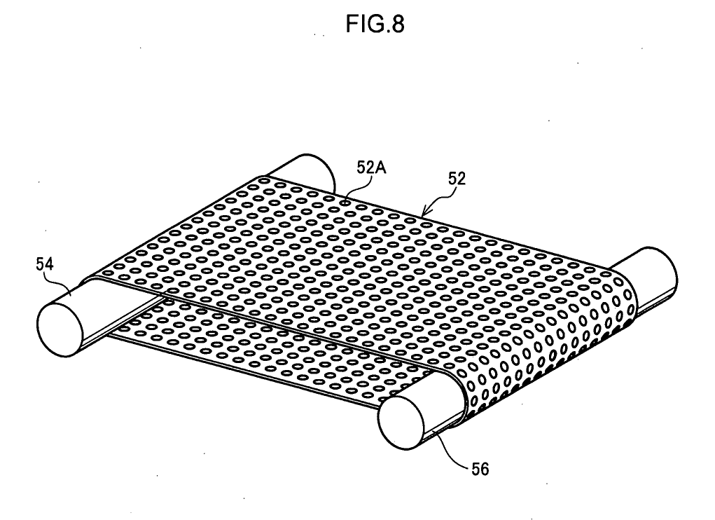

As shown in FIG. 7, the attraction image rendering section 50 of the present exemplary embodiment is equipped with a conveyer belt 52 and suction fans 19. The conveyer belt 52 is of an endless shape and is configured over the entire surface thereof with plural suction holes 52A for suctioning, as shown in FIG. 8. The conveyer belt 52 is entrained around belt rollers 54, 56. The belt roller 56 is disposed at the conveying direction downstream side and is rotationally driven by a non-illustrated motor so as to convey the recording paper SH toward the conveying direction downstream side. The belt roller 54 is capable of friction-pushed rotation. The conveyance speed V2 due to the belt roller 56 is the same as, or greater than, the conveyance speed V0 due to the slow-scan roller 14 (V2≧V0≧V1).

The suction fans 19 are disposed between the two sides of the conveyer belt 52. The suction fans 19 suction air such that there is a negative pressure at the top side portion of the attraction image rendering section 50. The recording paper SH on the attraction image rendering section 50 is thereby attracted onto the conveyer belt 52 from suctioning of the suction holes 52A and the flatness of the recording paper SH is maintained.

According to the present exemplary embodiment, in a similar manner to that in the first exemplary embodiment, generation of longitudinal creases, due to action of tensional force on the recording paper SH toward the downstream side, can be suppressed. In addition, since the first conveying rollers 20 are prevented from rotating in the opposite direction to the conveying direction, there is no influence of external force from the curved conveying section 30 acting on the attraction image rendering section 50, and good image rendering can be performed on the recording paper SH.

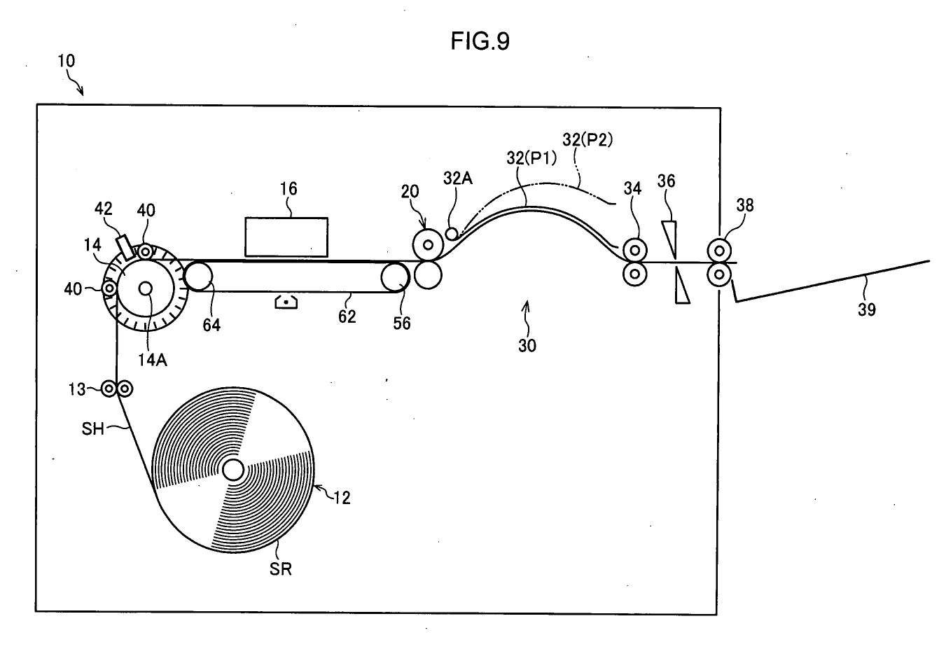

Note that while the present exemplary embodiment employs the conveyer belt 52 configured with the suction holes 52A and the suction fans 19, when the thickness of the recording paper SH is comparatively thin, then in place of these components an electrically charged belt 62 without suction holes and a charging roller 64 may be employed, as shown in FIG. 9, and the recording paper SH attracted by electrostatic attraction.

While the present invention has been explained by way of the exemplary embodiments described above, these are only exemplary embodiments, and various variations and modifications may be made within a scope not departing from the spirit of the present invention. The scope of the present invention is not limited by these exemplary embodiments.

What is claimed is:

1. An image forming device comprising:
a recording head that renders an image by ejecting liquid droplets onto a recording medium;
an attraction image rendering section comprising a liquid droplet reception flat portion disposed facing the recording head, the attraction image rendering section attracting the recording medium onto the flat portion and maintaining the flatness of the recording medium;
an upstream side conveying section that feeds the recording medium out toward the attraction image rendering section; and
a reverse-feed-prevented conveying roller disposed at the downstream side of the attraction image rendering section, the reverse-feed-prevented conveying roller being capable of friction-pushed rotation toward the conveying direction downstream side, nipping the recording medium and feeding the recording medium toward the conveying direction downstream side, and prevented from rotation toward the conveying direction upstream side.

2. The image forming device of claim 1, wherein the reverse-feed-prevented conveying roller is capable of being rotationally driven toward the conveying direction downstream side at a conveyance speed that is the same as, or less than, a conveyance speed of the upstream side conveying section.

3. The image forming device of claim 1, wherein the reverse-feed-prevented conveying roller nips the recording medium against the top face of the flat portion.

4. The image forming device of claim 2, wherein the reverse-feed-prevented conveying roller nips the recording medium against the top face of the flat portion.

5. The image forming device of claim 1, wherein the relationship
S<2π(E×I/F)^{1/2} is satisfied, wherein:
S is a separation distance between the downstream end of the flat portion and a nip portion of the recording medium at the reverse-feed-prevented conveying roller; F is the friction-pushed load on the reverse-feed-prevented conveying roller; E is the Young's modulus of the recording medium; and I is the area moment of inertia of the recording medium.

6. The image forming device of claim 2, wherein the relationship
S<2π(E×I/F)^{1/2} is satisfied, wherein:
S is a separation distance between the downstream end of the flat portion and a nip portion of the recording medium at the reverse-feed-prevented conveying roller; F is the friction-pushed load on the reverse-feed-prevented conveying roller; E is the Young's modulus of the recording medium; and I is the area moment of inertia of the recording medium.

7. The image forming device of claim 3, wherein the relationship
S<2π(E×I/F)^{1/2} is satisfied, wherein:
S is a separation distance between the downstream end of the flat portion and a nip portion of the recording medium at the reverse-feed-prevented conveying roller; F is the friction-pushed load on the reverse-feed-prevented conveying roller; E is the Young's modulus of the recording medium; and I is the area moment of inertia of the recording medium.

8. The image forming device of claim 4, wherein the relationship
S<2π(E×I/F)^{1/2} is satisfied, wherein:
S is a separation distance between the downstream end of the flat portion and a nip portion of the recording medium at the reverse-feed-prevented conveying roller; F is the friction-pushed load on the reverse-feed-prevented conveying roller; E is the Young's modulus of the recording medium; and I is the area moment of inertia of the recording medium.

9. The image forming device of claim 1, wherein the recording medium is fed out from a wound state of a roll shape toward the flat portion with an unwind direction having the convex face of the recording medium facing toward the recording head in the attraction image rendering section.

10. The image forming device of claim 9, further comprising:
second conveying rollers that are provided at the conveying direction downstream side of the reverse-feed-prevented conveying roller, and that nip the recording medium and convey the recording medium toward the downstream side;
a cutter section that cuts the recording medium to a specific size; and
a curved conveying section that is provided between the reverse-feed-prevented conveying roller and the second conveying rollers and that bends the recording medium and accommodates any difference in conveying amounts between the reverse-feed-prevented conveying roller and the second conveying rollers due to conveyance being stopped in the cutter section when the recording medium is being cut.

11. The image forming device of claim 10, wherein the direction of curvature of the recording medium in the curved conveying section is the same direction as the winding direction of the recording medium.

12. The image forming device of claim 10, wherein the direction of curvature of the recording medium in the entire region between the reverse-feed-prevented conveying roller and the second conveying rollers is the same as the winding direction of the recording medium.
